(19) United States
(12) Patent Application Publication
(10) Pub. No.: US 2025/0282192 A1
(43) Pub. Date: Sep. 11, 2025

(54) CONNECTOR AND MOVABLE OBJECT INCLUDING THE SAME

(71) Applicants: Hyundai Motor Company, Seoul (KR); Kia Corporation, Seoul (KR)

(72) Inventor: Myung Hwan KIM, Hwaseong-Si (KR)

(73) Assignees: Hyundai Motor Company, Seoul (KR); Kia Corporation, Seoul (KR)

(21) Appl. No.: 18/929,942

(22) Filed: Oct. 29, 2024

(30) Foreign Application Priority Data
Mar. 7, 2024 (KR) 10-2024-0032778

(51) Int. Cl. B60D 1/64

(52) U.S. Cl. CPC B60D 1/64

(57) ABSTRACT

A connector for connecting a first pipeline and a second pipeline includes a connector body including a connection passage that connects the first pipeline and the second pipeline, an opening/closing body movably coupled to the connector body to be movable between an opening position, in which the connection passage is opened, and a closing position, in which the connection passage is closed, and an elastic body that elastically supports the opening/closing body toward the closing position.

### CROSS-REFERENCE TO RELATED APPLICATION

The present application claims priority to Korean Patent Application No. 10-2024-0032778, filed on Mar. 7, 2024, the entire contents of which is incorporated herein for all purposes by this reference.

### BACKGROUND OF THE PRESENT DISCLOSURE

### Field of the Present Disclosure

The present disclosure relates to a connector and a movable object including the same, and more particularly, to a connector for connecting pipelines, and a movable object including the same.

### Description of Related art

Vehicles may be used to transport cargo or passengers to destinations thereof. These vehicles may include a circulation system for circulating a cooling fluid. As an example, the circulation system provided in a vehicle may be used to cool an engine or a motor by circulating the cooling fluid.

Meanwhile, a cargo loading structure may be detachably coupled to the vehicle. The cargo loading structure is a structure that has a loading space to increase an efficiency of transportation of cargo. As an example, the cargo loading structure may be a container. Through this, the vehicle may transport more cargo at once.

Then, the cargo loading structure coupled to the vehicle may be provided with a separate circulation system for the cooling fluid in consideration of the characteristics of the loaded cargo. For example, the cargo loading structure may be provided with a cooler or heater to maintain a temperature of a loading space in a specific range.

The cooler may absorb thermal energy from the loading space by use of the cooling fluid, and the heater may supply thermal energy stored in the cooling fluid to the loading space. Accordingly, various types of cargo may be safely transported while maintaining temperature.

Then, the cooler or the heater of the cargo loading structure may be fluidly connected to the circulation system provided in the vehicle to receive the cooling fluid. This may contribute to the cargo loading structure securing a wider loading space. This is because the cooler or the heater can circulate the cooling fluid by use of the pump and/or the heat-exchanger of the circulation system provided in the vehicle.

To achieve this, the heater and/or the cooler of the cargo loading structure and the circulation system provided in the vehicle should be fluidly connected to each other. Generally, the above connection is made by a connector that connects pipelines.

However, conventionally, the cooling fluid filled in the cooler or heater has to be extracted to the outside every time before the cargo loading structure is coupled to or uncoupled from the vehicle. During a process of coupling or uncoupling the vehicle and the cargo loading structure, the connector and the pipeline of the circulation system become separated from each other, and the cooling fluid filled in the circulation system may be leaked to the outside thereof.

This increases a time and a labor required to maintain vehicles or replace cargo loading structures. Accordingly, there has been an urgent demand for the development of a connector which may prevent fluid leakage during the process of connecting or disconnecting the pipelines.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a connector which may prevent fluid leakage during a process of connecting or disconnecting pipelines, and a movable object including the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a connector for connecting a first pipeline and a second pipeline includes a connector body including a connection passage that connects the first pipeline and the second pipeline, an opening/closing body movably coupled to the connector body to be movable between an opening position, in which the connection passage is opened, and a closing position, in which the connection passage is closed, and an elastic body that elastically supports the opening/closing body toward the closing position.

Accordingly, the connector body may include a hollow body portion including an opening on one side thereof, and the opening/closing body may be located on an inside of the body portion.

Accordingly, the connector body may further include a movement restricting portion that restricts the opening/closing body from being moved from the closing position toward the opening of the body portion.

Accordingly, the movement restricting portion may protrude from an internal peripheral surface of the body portion so that the opening/closing body is stopped by the movement restricting portion.

Accordingly, the opening/closing body may include a rotation shaft coupled to the body portion to be rotatable, and an opening/closing portion connected to the rotation shaft to be rotatable about the rotation shaft, and that blocks an interior of the body portion in the closing position.

Accordingly, the opening/closing portion may be formed in a plate shape.

Accordingly, a cross-section of the body portion, which is perpendicular to a flow direction of a fluid in the body portion, may be circular or elliptical, and the opening/closing portion may be formed of a circular or elliptical plate.

Accordingly, the opening/closing body may further include a sealing portion provided on a peripheral side of the opening/closing portion.

Accordingly, the sealing portion may be provided in an external circumferential surface facing an internal peripheral surface of the body portion in the closing position.

Accordingly, the sealing portion may include an O-ring surrounding the opening/closing portion.

Accordingly, the connector body may further include an accommodation portion provided at a side portion of the body portion, and that provides an accommodation space connected to an interior of the body portion, and wherein at least a portion of the opening/closing portion is disposed in the accommodation space in the opening position.

Accordingly, the accommodation portion may include a recess recessed in an outward direction of the body portion on an internal wall of the body portion.

Accordingly, the opening/closing portion may include an opening/closing surface disposed to face the opening of the body portion in the closing position, and that blocks an interior of the body portion, and the opening/closing surface may include a concave shape recessed in an outward direction of the body portion in the opening position.

Accordingly, the elastic body may be a torsion spring coupled to the rotation shaft.

Accordingly, the elastic body may include a pair of spring portions coupled to opposite end portions of the rotation shaft, respectively, a pair of fixed portions extending from the pair of spring portions, respectively, and fixed to the body portion, and an elastic support portion provided between the pair of spring portions so that the opening/closing portion is supported toward the closing position by use of elasticity of the spring portion.

Accordingly, a plurality of opening/closing bodies may be provided to open or close a portion of the connection passage.

Accordingly, a plurality of elastic bodies may be provided to correspond to the number of the plurality of opening/closing bodies to elastically support the plurality of opening/closing bodies, respectively.

Accordingly, when a cross-section of the connection passage, which is perpendicular to a flow direction of a fluid, is defined as a flow surface, the opening/closing bodies may open or close different portions of the flow surface, respectively so that the plurality of opening/closing bodies open or close the flow surface.

According to another aspect of the present disclosure, a movable object includes a vehicle body including a wheel for traveling, a first circulation system supported by the vehicle body, a structure coupled to the vehicle body, a second circulation system supported by the structure, and a connector connecting a first pipeline of the first circulation system and a second pipeline of the second circulation system, the connector includes a connector body including a connection passage that connects the first pipeline and the second pipeline, an opening/closing body coupled to be movable from an opening position, in which the connection passage is opened, to a closing position, in which the connection passage is closed, in the connector body, and an elastic body that elastically supports the opening/closing body toward the closing position.

Accordingly, the structure may be coupled to be attached to or detached from the vehicle body, and the opening/closing body may open the connection passage in response that the structure is coupled to the vehicle body, and close the connection passage in response that the structure is decoupled from the vehicle body.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram schematically illustrating a movable object according to an exemplary embodiment of the present disclosure. Accordingly, a cross-section of a cargo loading structure is illustrated so that an interior thereof may be viewed;

FIG. 2 and FIG. 3 are side views exemplarily illustrating a state, in which a first pipeline and a second pipeline are connected to each other by a connector according to various exemplary embodiments of the present disclosure. Accordingly, in FIG. 3, a connector body is indicated by a dotted line, and a configuration which is projected by the connector body is indicated by a solid line;

FIG. 4 is a view exemplarily illustrating a process of connecting a first pipeline and a second pipeline by a connector according to the various exemplary embodiments of the present disclosure. Accordingly, the connector body is illustrated in a cross-section so that an interior thereof may be viewed;

FIG. 5 is a perspective view an opening/closing body and an elastic body of a connector according to the various exemplary embodiments of the present disclosure, when viewed from a front side;

FIG. 6 is a perspective view of an opening/closing body and an elastic body of a connector according to the various exemplary embodiments of the present disclosure, when viewed from a rear side;

FIG. 7 is a cross-sectional view obtained by cutting a first pipeline and a second pipeline connected to each other by a connector according to the various exemplary embodiments of the present disclosure so that interiors thereof are viewed;

FIG. 8 is a cross-sectional view of the connector illustrated in FIG. 7, taken along a plane which is perpendicular to a forward/rearward direction thereof;

FIG. 9 is a perspective view of an opening/closing body of a connector according to various exemplary embodiments of the present disclosure, when viewed from a top;

FIG. 10 is a cross-sectional view of a connector according to the various exemplary embodiments of the present disclosure, taken along a plane which is perpendicular to a forward/rearward direction thereof;

FIG. 11 is a perspective view of an opening/closing body and an elastic body of a connector according to the various exemplary embodiments of the present disclosure, when viewed from a top. Accordingly, a connection passage is indicated by a dotted line, and a flow surface is indicated by a hatched surface; and

FIG. 12 is a longitudinal cross-sectional view of a connector according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Embodiments of the present disclosure will be described in detail so that those with knowledge may easily implement the present disclosure. However, the present disclosure may be implemented in several different forms, and is not limited or restricted by the following embodiments.

To clearly describe the present disclosure, a detailed description of parts that are not related to the description or related well-known technologies which may unnecessarily obscure the gist of the present disclosure will be omitted, and in adding reference numerals to the components of the drawings, it is noted that the same components are denoted by the same reference numerals throughout the specification.

Furthermore, terms and words used in the specification and the claims should not be construed as being limited to their ordinary or dictionary meanings, and should be construed as meanings and concepts that are consistent with the technical idea of the present disclosure based on the principle that the inventor may appropriately define terminological concepts to best describe his or her invention.

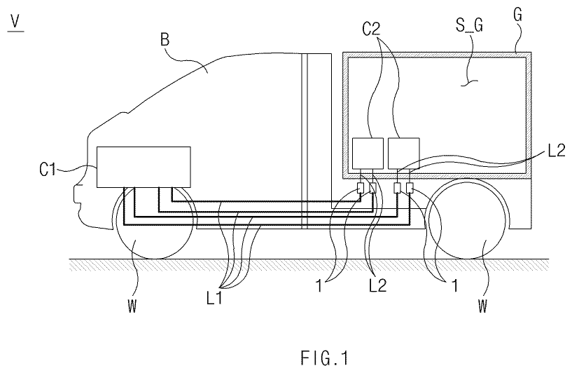

FIG. 1 is a diagram schematically illustrating a movable object according to an exemplary embodiment of the present disclosure. Accordingly, a cross-section of a cargo loading structure is illustrated so that an interior thereof may be viewed.

In FIG. 1, a movable object “V” according to an exemplary embodiment of the present disclosure is disclosed. Referring to FIG. 1, the movable object “V” according to an exemplary embodiment of the present disclosure may be a movable object for transporting specific cargo or passengers. As an exemplary embodiment of the present disclosure, the movable object “V” according to an exemplary embodiment of the present disclosure may be a vehicle, but the present disclosure is not limited thereto.

The movable object “V” according to an exemplary embodiment of the present disclosure may include a vehicle body “B”, a driving device, and a wheel “W”. In the exemplary embodiment of the present disclosure, the vehicle body “B” may provide a base, on which other components of the movable object “V” are provided. The vehicle body “B” may define an overall external appearance of the movable object “V”.

In the exemplary embodiment of the present disclosure, the driving device may be a device that generates a driving force. The driving device may be supported by the vehicle body “B”. As an exemplary embodiment of the present disclosure, the driving device may be an engine. In the case, the movable object “V” may be an internal combustion engine vehicle. As an exemplary embodiment of the present disclosure, the driving device may be a motor. In the case, the movable object “V” may be an electric vehicle.

In the exemplary embodiment of the present disclosure, the wheel “W” may be coupled to the vehicle body “B” to be rotatable. A plurality of wheels “W” may be provided, and may be spaced apart from each other along a circumference of the vehicle body “B”. The wheel “W” may be operatively connected to the driving device coupled to the vehicle body “B”. The wheel “W” may be rotated by the driving force generated by the driving device. Accordingly, the movable object “V” may travel.

Meanwhile, in the exemplary embodiment of the present disclosure, the movable object “V” may include a first circulation system C1. The first circulation system C1 may be a system for maintaining other components of the movable object “V” in a specific temperature range by circulating a cooling fluid. Accordingly, the cooling fluid may include cooling water, but the present disclosure is not limited thereto.

In the exemplary embodiment of the present disclosure, the first circulation system C1 may be a system for cooling the above-described driving device (e.g., an engine or a motor). To achieve this, the first circulation system C1 may include a tank which may accommodate the cooling fluid, a heat-exchanger for exchange heat between the cooling fluid and external air, and a pump for circulating the cooling fluid. The first circulation system C1 may include various components for circulating and heat-exchanging the cooling fluid.

Referring back to FIG. 1, the movable object “V” according to an exemplary embodiment of the present disclosure may include a structure “G” for performing a specific function. The structure “G” may be coupled to the vehicle body “B” to perform the above function. Accordingly, the structure “G” may be detachably coupled to the vehicle body “B”.

As a non-limiting example, the structure “G” may be the cargo loading structure “G”. The cargo loading structure “G” may be a structure which is provided with a loading space S_G, in which a specific amount of cargo may be loaded, in an interior thereof. As an exemplary embodiment of the present disclosure, the cargo loading structure “G” may be a container which is a box-shaped structure, but the present disclosure is not limited thereto.

Accordingly, in the exemplary embodiment of the present disclosure, the cargo loading structure “G” may include a second circulation system C2, through which the cooling fluid may circulate. The second circulation system C2 may be a system that exchanges heat between the cooling fluid and the loading space S_G to maintain a temperature of the loading space S_G in a specific range.

For example, the second circulation system C2 may include a cooler for lowering the temperature by absorbing thermal energy of the loading space S_G, and/or a heater for increasing the temperature by supplying thermal energy to the loading space S_G. A type of the second circulation system C2 may be appropriately changed depending on a type of the cargo which is loaded.

Accordingly, the second circulation system C2 may be configured to receive the cooling fluid from the first circulation system C1. This may eliminate a need to provide separate devices (e.g., pumps, and the like) for circulating the cooling fluid in the cargo loading structure “G”. Accordingly, the loading space S_G may become wider.

As described above, for the second circulation system C2 and the first circulation system C1 to exchange the cooling fluid, a second pipeline L2 provided in the second circulation system C2 and a first pipeline L1 provided in the first circulation system C1 need to be fluidly connected to each other.

To achieve this, the movable object “V” according to an exemplary embodiment of the present disclosure may include a connector 1. The connector 1 may be a connector that connects and/or disconnects the first pipeline L1 and the second pipeline L2. The first pipeline L1 and the second pipeline L2 may exchange the cooling fluid through the connector 1.

Meanwhile, in the exemplary embodiment of the present disclosure, as described above, the cargo loading structure “G” may be detachably coupled to the vehicle body “B”. In a process of coupling or separating the cargo loading structure “G” to or from the vehicle body “B”, the first pipeline L1 and the second pipeline L2 are connected to or separated from each other.

Accordingly, the connector 1 of the movable object “V” according to the exemplary embodiment of the present disclosure may be configured to prevent leakage of the cooling fluid that flows through the first pipeline L1 and the second pipeline L2 in a process of connecting or separating the first pipeline L1 and the second pipeline L2.

Accordingly, the cargo loading structure “G” may be safely coupled to or separated from the vehicle body “B” without extracting the cooling fluid filled in the first and/or second circulation systems C1 and C2 to an outside thereof. Accordingly, a time and a labor that are required to maintain the movable object “V” or replace the cargo loading structure “G” may be significantly reduced.

Hereinafter, the connector according to the exemplary embodiment of the present disclosure will be described in detail in different drawings.

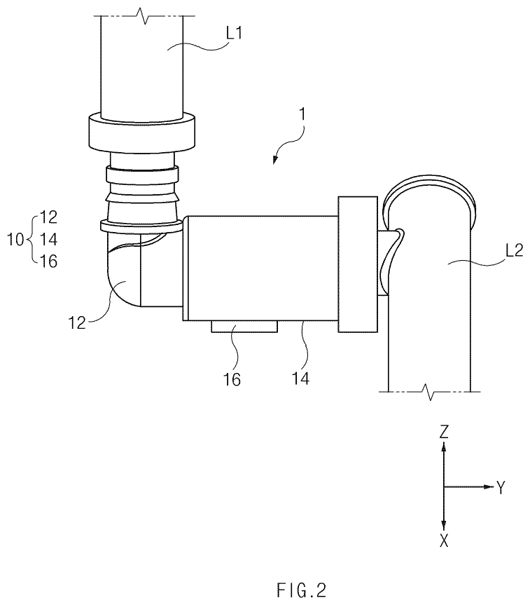

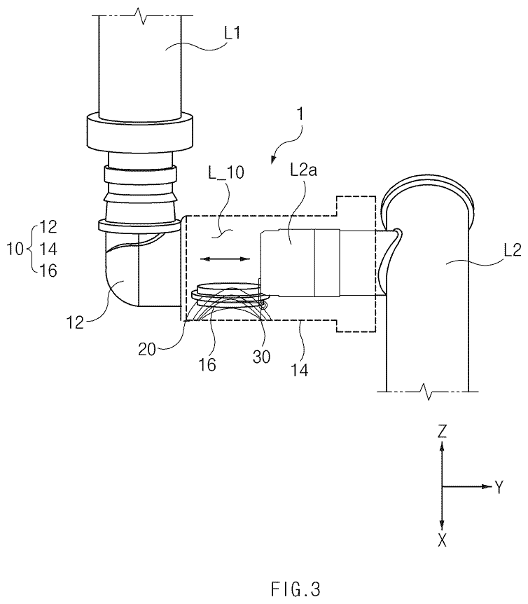

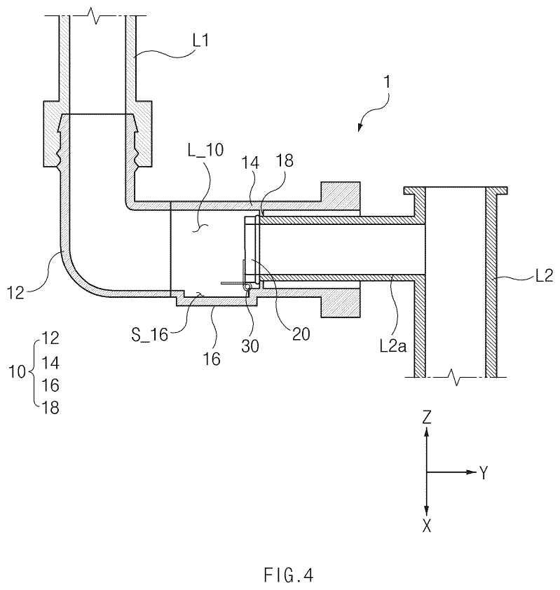

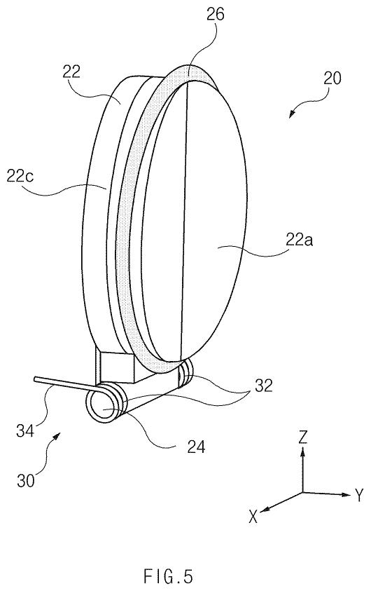

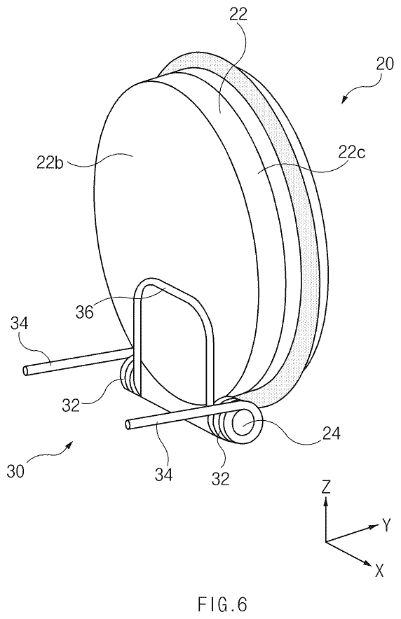

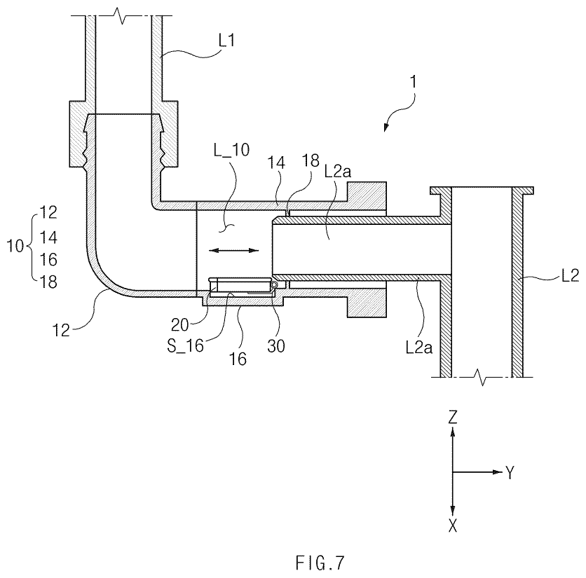

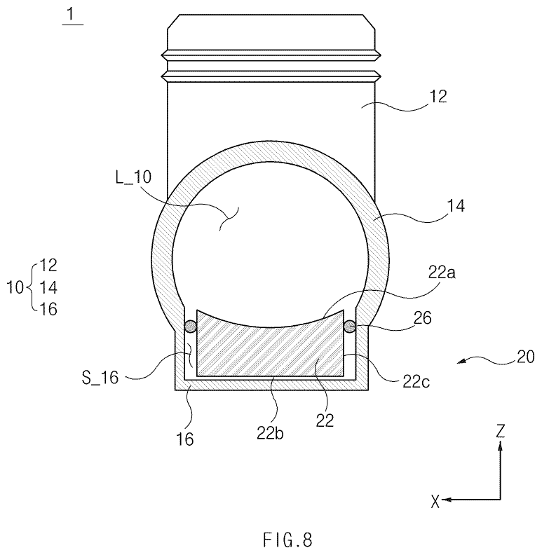

FIG. 2 and FIG. 3 are side views exemplarily illustrating a state, in which a first pipeline and a second pipeline are connected to each other by a connector according to various exemplary embodiments of the present disclosure. Accordingly, in FIG. 3, a connector body is indicated by a dotted line, and a configuration which is projected by the connector body is indicated by a solid line. FIG. 4 is a view exemplarily illustrating a process of connecting a first pipeline and a second pipeline by a connector according to the various exemplary embodiments of the present disclosure. Accordingly, the connector body is illustrated in a cross-section so that an interior thereof may be viewed. FIG. 5 is a perspective view an opening/closing body and an elastic body of a connector according to the various exemplary embodiments of the present disclosure, when viewed from a front side thereof. FIG. 6 is a perspective view of an opening/closing body and an elastic body of a connector according to the various exemplary embodiments of the present disclosure, when viewed from a rear side thereof. FIG. 7 is a cross-sectional view obtained by cutting a first pipeline and a second pipeline connected to each other by a connector according to the various exemplary embodiments of the present disclosure so that interiors thereof are viewed. FIG. 8 is a cross-sectional view of the connector illustrated in FIG. 7, taken along a plane which is perpendicular to a forward/rearward direction thereof.

In FIG. 2, FIG. 3, FIG. 4, FIG. 5, FIG. 6, FIG. 7, and FIG. 8, a connector 1 according to the various exemplary embodiments of the present disclosure is disclosed. Referring to FIG. 2, FIG. 3 and FIG. 4, the connector 1 according to the various exemplary embodiments of the present disclosure may include a connector body 10.

In the exemplary embodiment of the present disclosure, the connector body 10 may be a body for providing a connection passage L_10. Here, the connection passage L_10 may be a passage that fluidly connects the first pipeline L1 and the second pipeline L2.

In the exemplary embodiment of the present disclosure, the connector body 10 may include body portions 12 and 14. The body portions 12 and 14 may define an overall external appearance of the connector 1. The body portions 12 and 14 may be provided in a hollow shape. Accordingly, the above-described connection passage L_10 may be provided in an interior of body portions 12 and 14.

In the exemplary embodiment of the present disclosure, the body portions 12 and 14 may include a first body portion 12 and a second body portion 14. The first body portion 12 may be a portion which is connected to the first pipeline L1 in the body portions 12 and 14, and the second body portion 14 may be a portion which is connected to the second pipeline L1 in the body portions 12 and 14.

As in the illustrated exemplary embodiment of the present disclosure, the first body portion 12 may be formed of a curved pipe, of which a portion is curved. One end portion of the first body portion 12 may be opened. The one open end portion of the first body portion 12 may be connected to the first pipeline L1. As an exemplary embodiment of the present disclosure, the end portion of the first body portion 12 may be fitted into an inside of the first pipeline L1. A coupling structure of the first body portion 12 and the first pipeline L1 is not limited.

In the exemplary embodiment of the present disclosure, a second body portion 14 may be connected to an opposite end portion of the first body portion 12. The second body portion 14 may include a pipeline shape that extends in one direction thereof. One end portion of the second body portion 14 may be opened toward the second pipeline L2. In other words, an opening 50 may be provided at one end portion of the second body portion 14. The opening may be connected to the connection passage L_10 of the body portions 12 and 14. Meanwhile, an opposite end portion of the second body portion 14 may be coupled to an opposite end portion of the first body portion 12.

Accordingly, the second pipeline L2 may be inserted into and coupled to the opening of the second body portion 14. In more detail, as illustrated in FIG. 3 and FIG. 4, a portion L2a of the second pipeline L2 may be inserted into an inside of the opening of the second body portion 14. To achieve this, the internal diameter of the second body portion 14 may be greater than or equal to the external diameter of the portion L2a of the second pipeline L2. The difference may be appropriately adjusted considering a coupling tolerance.

Accordingly, a specific opening may be provided at the portion L2a of the second pipeline L2. As the opening of the second pipeline L2 and the connection passage L_10 communicates with each other, the first pipeline L1 and the second pipeline L2 may exchange the cooling fluid.

Meanwhile, in the illustrated exemplary embodiment of the present disclosure, it is illustrated that the first body portion 12 and the second body portion 14 are provided as separate members. However, when necessary, the first body portion 12 and the second body portion 14 may be provided integrally. Here, the fact that the first body portion 12 and the second body portion 14 are provided integrally may mean that the first body portion 12 and the second body portion 14 are connected to each other and are not physically and spatially separated from each other.

Referring to FIG. 2, FIG. 3 and FIGS. 4 and 8, in the exemplary embodiment of the present disclosure, the connector body 10 may include an accommodation portion 16. The accommodation portion 16 may be a portion for accommodating an opening/closing body 20, which will be described later, in the connector body 10. Accordingly, the opening/closing body 20 accommodated in the accommodation portion 16 may be the opening/closing body 20 positioned at the opening position that will be described later.

In the exemplary embodiment of the present disclosure, the accommodation portion 16 may be located on a side portion of the second body portion 14. Accordingly, the side portion of the second body portion 14 may mean a portion in a direction which is perpendicular to a direction, in which the cooling fluid flows in the second body portion 14. The accommodation portion 16 may include a shape that protrudes (or extends) from the second body portion 14 in an outward direction of the second body portion 14. Accordingly, the outward direction of the second body portion 14 may be a direction which is perpendicular to a direction, in which the cooling fluid flows in the second body portion 14.

Accordingly, an accommodation space S_16 may be provided in an interior of the accommodation portion 16. The accommodation space S_16 may be located on a side portion of the connection passage L_10. The accommodation space S_16 may communicate with (or be connected to) the connection passage L_10 of the second body portion 14. Accordingly, the opening/closing body 20 that closes the connection passage L_10 may enter the accommodation space S_16 to open the connection passage L_10.

Accordingly, a shape of the accommodation space S_16 may correspond to an external appearance of the opening/closing body 20. In other words, an internal surface of the accommodation portion 16, which defines the accommodation space S_16, may face a facing surface 22b and an external circumferential surface 22c, which define an external surface of the opening/closing body 20, and are in parallel to each other.

A distance between the internal surface of the accommodation portion 16 and the external surface of the opening/closing body 20 may be appropriately adjusted considering a coupling tolerance, and the like. Accordingly, the connector 1 may be provided in a more compact and simple structure, and an influence of the flow of the connection passage L_10 due to the accommodation space S_16 may be minimized.

Meanwhile, referring to FIG. 3 and FIG. 4, the connector body 10 according to the various exemplary embodiments of the present disclosure may include movement restricting portion including a stop portion 18. The stop portion 18 may be configured to restrict the opening/closing body 20, which will be described later, from being moved further from the closing position toward the opening of the second body portion 14. Accordingly, the opening of the second body portion 14 may be an opening, into which a portion L2a of the second pipeline L2 is inserted.

In the exemplary embodiment of the present disclosure, the stop portion 18 may be provided on an internal peripheral surface of the second body portion 14. The stop portion 18 may protrude (or extend) from the internal peripheral surface of the second body portion 14 to an inside of the second body portion 14. Accordingly, the stop portion 18 may protrude (or extend) from the second body portion 14 in a direction which is perpendicular to a direction, in which the cooling fluid flows.

Accordingly, when viewed from the flow direction of the cooling fluid, the stop portion 18 may include an annular shape which is formed in a circumferential direction of the second body portion 14. An internal diameter of the stop portion 18 may be smaller than an external diameter of an opening/closing portion 22 of the opening/closing body 20, which will be described later. Furthermore, the internal diameter of the stop portion 18 may be greater than the external diameter of the portion L2a of the second pipeline L2.

Accordingly, while the opening/closing body 20 may be stopped by the stop portion 18, the portion L2a of the second pipeline L2 may be inserted past an inside of the stop portion 18. Of course, when necessary, the stop portion 18 may be partially provided only in one circumferential section of the second body portion 14. The stop portion 18 may be modified into various structures which may restrict the movement of the opening/closing body 20.

Meanwhile, referring to FIGS. 2 to 6, the connector 1 according to the various exemplary embodiments of the present disclosure may include an opening/closing body 20. The opening/closing body 20 may be configured to open or close the connection passage L_10. Accordingly, the opening/closing body 20 may be coupled to the connector body 10 to be movable, so that the opening/closing operation described above may be performed.

Hereinafter, as illustrated in FIG. 3, a position, in which the opening/closing body 20 opens the connection passage L_10, is named the opening position, and as illustrated in FIG. 4, a position, in which the opening/closing body 20 closes the connection passage, is named the closing position.

Referring to FIG. 4, FIG. 5, FIG. 6, and FIG. 7, in the exemplary embodiment of the present disclosure, the opening/closing body 20 may include an opening/closing portion 22. The opening/closing portion 22 may be configured to directly open or close the connection passage L_10.

In the exemplary embodiment of the present disclosure, the opening/closing portion 22 may include a plate shape. Accordingly, the opening/closing body 20 may close the connection passage L_10 while blocking one section of the connection passage L_10. Accordingly, the opening/closing body 20 may be provided in a structure which is as compact and simple as possible. Accordingly, the plate may be a concept that includes not only a shape including a constant thickness, but also a shape, in which a thickness of a portion and a thickness of other portions have different sizes.

Meanwhile, in the exemplary embodiment of the present disclosure, the opening/closing portion 22 may correspond to the shape of the second body portion 14. A cross-section of the second body portion 14, which is perpendicular to the flow direction of the cooling fluid in the second body portion 14, may be circular or elliptical, and the opening/closing portion 22 also may include a circular or elliptical plate corresponding to its cross-sectional shape of the second body portion 14.

As illustrated in FIG. 4, the opening/closing portion 22 may be disposed to block the connection passage L_10 in the closing position. Furthermore, as illustrated in FIGS. 7 and 8, the opening/closing portion 22 may be disposed to enter the accommodation space S_16 in the opening position to open the connection passage L10.

In the exemplary embodiment of the present disclosure, the opening/closing portion 22 may include an opening/closing surface 22a, a facing surface 22b, and an external circumferential surface 22c. The opening/closing surface 22a may be a surface that faces the opening of the second body portion 14 in the closing position. Accordingly, the opening of the second body portion 14 may be an opening, into which a portion L2a of the second pipeline L2 is inserted. Accordingly, the opening/closing surface 22a blocks an interior of the second body portion 14 in the closing position.

Accordingly, in the exemplary embodiment of the present disclosure, the opening/closing surface 22a may be formed as a concavely recessed curved surface. Here, a direction, in which the opening/closing surface 22a is recessed, may be a direction that faces an outside of the second body portion 14 with respect to the opening position.

In more detail, in the opening position, a center portion of the opening/closing surface 22a may include a relatively low height, and the side portions may include a relatively high height. Furthermore, the height of the opening/closing surface 22a may gradually increase as it goes from the center portion to the side portions. Accordingly, the relative positions of the center portion and the side portions of the opening/closing surface 22a may be defined along the circumferential direction of the second body portion 14.

To achieve this, the opening/closing portion 22 may have a relatively thin center portion and a relatively thick side portion. Furthermore, the thickness of the opening/closing portion 22 may gradually increase as it goes from the center portion to the side portions.

This may be for minimizing the influence on the flow of cooling fluid that flows through the connection passage L_10 when the opening/closing body 20 is located in the opening position. For example, the curved surface of the opening/closing surface 22a may minimize a flow resistance of the cooling fluid.

To further improve the above-described effect, the opening/closing surface 22a may be configured to be connected to the internal peripheral surface of the second body portion 14 in the opening position. Here, connecting two surfaces may mean that the two surfaces are connected to each other with no step. This may restrain an increase in the flow resistance due to the formation of unnecessary vortices at a boundary between the opening/closing surface 22a and the internal peripheral surface of the second body portion 14.

Accordingly, a curvature of a concave curve of the opening/closing surface 22a may be the same as a curvature of an internal peripheral surface of the second body portion 14 in a specific range. Accordingly, the opening/closing surface 22a and the internal peripheral surface of the second body portion 14 may be connected to each other more naturally and smoothly.

Meanwhile, in the exemplary embodiment of the present disclosure, a facing surface 22b of the opening/closing portion 22 may be a surface that faces the opening/closing surface 22a. The external circumferential surface 22c may be a surface which is provided between the opening/closing surface 22a and the facing surface 22b to connect the opening/closing surface 22a and the facing surface 22b. The external circumferential surface 22c may be formed in a thickness direction of the opening/closing portion 22. The external circumferential surface 22c may be disposed to face the internal peripheral surface of the second body portion 14 in the closing position.

Accordingly, the cooling fluid may be leaked between the external circumferential surface 22c of the opening/closing portion 22 and the internal peripheral surface of the second body portion 14 in the closing position. To prevent this, a sealing portion 26 may be provided in the external circumferential surface 22c. The sealing portion 26 may be formed of an O-ring that surrounds the opening/closing portion 22. The structure and the shape of the sealing portion 26 may be appropriately modified as needed.

Referring back to FIG. 4, FIG. 5, FIG. 6, and FIG. 7, the opening/closing body 20 of the connector 1 according to the various exemplary embodiments of the present disclosure may include a rotation shaft 24. The rotation shaft 24 may be coupled to the second body portion 14 to be rotatable. Furthermore, the above-described opening/closing portion 22 may be connected to the side portion of the rotation shaft 24.

Accordingly, the opening/closing portion 22 may be rotated about the rotation shaft 24, and the opening/closing body 20 may be moved from the opening position to the closing position, or from the closing position to the opening position.

Meanwhile, referring to FIG. 5, FIG. 6 and FIG. 7, the connector 1 according to the various exemplary embodiments of the present disclosure may include an elastic body 30. The elastic body 30 may be configured to elastically support the opening/closing body 20 toward the closing position. As an exemplary embodiment of the present disclosure, the elastic body 30 may be a torsion spring which is coupled to the rotation shaft 24.

Through this, the elastic body 30 may perform a function of preventing leakage of the cooling fluid together with the opening/closing body 20 during a process of connecting or disconnecting the first pipeline L1 and the second pipeline L2. These functions will be described in detail later.

Referring to FIG. 4, FIG. 5 and FIG. 6, the elastic body 30 of the connector according to the various exemplary embodiments of the present disclosure may include a pair of spring portions 32. A pair of spring portions 32 may pass through and be coupled to the rotation shaft 24 of the opening/closing body 20.

Accordingly, the pair of spring portions 32 may be coupled to opposite axial end portions of the rotation shaft 24. The pair of spring portions 32 may be located to be symmetrical to each other with respect to the opening/closing portion 22. Through this, the pair of spring portions 32 may apply an elastic force that will be described later so that it is symmetrically balanced with the opening/closing portion 22.

In the exemplary embodiment of the present disclosure, the elastic body 30 may include a fixed portion 34. The fixed portion 34 may extend (or protrude) from the spring portion 32. An end side of the fixed portion 34 may be fixed or stopped by the second body portion 14. A predetermined elastic deformation may be induced in the spring portion 32 by a force of the second body portion 14 supporting the fixed portion 34.

Accordingly, a pair of fixed portions 34 may be provided. Furthermore, the pair of fixed portions 34 may be connected to the pair of spring portions 32, respectively. Through this, a support force of the second body portion 14 may be applied in a balanced manner to the spring portion 32 through the pair of fixed portions 34.

In the exemplary embodiment of the present disclosure, the elastic body 30 may include an elastic support portion 36. The elastic support portion 36 may be configured to elastically support the opening/closing portion 22 toward the closing position. The elastic support portion 36 may be located between the pair of spring portions 32. Opposite sides of the elastic support portion 36 may be connected to the pair of spring portions 32, respectively. Due to the provided configuration, an elastic force due to the elastic deformation of the spring portion 32 may be applied to the elastic support portion 36.

In the exemplary embodiment of the present disclosure, the elastic support portion 36 may contact with the facing surface 22b of the opening/closing portion 22. The elastic support portion 36 may apply a specific force on the facing surface 22b of the opening/closing portion 22. The opening/closing portion 22 may receive a specific elastic force in a direction that faces the opening/closing surface 22a from the facing surface 22b by the elastic support portion 36.

Through this, the opening/closing portion 22 may be rotated about the rotation shaft 24 based on the elastic force of the elastic body 30, and may be elastically supported in a direction that faces the closing position from the opening position.

Hereinafter, it will be described that leakage of the cooling fluid is prevented in a process of connecting the first pipeline and the second pipeline by the connector according to the various exemplary embodiments of the present disclosure.

Referring to FIG. 4 and FIG. 5, a state, in which the second pipeline L2 is not connected to the second body portion 14 of the connector 1 according to the various exemplary embodiments of the present disclosure, is disclosed. In the instant state, the opening/closing body 20 may be located in the closing position, and the elastic body 30 may elastically support the opening/closing body 20 toward the closing position.

Accordingly, because the opening/closing body 20 is caught by the stop portion 18 of the connector body 10, it may not be pushed excessively toward the opening side of the second body portion 14. Here, the opening of the second body portion 14 may be an opening, into which the portion L2a of the second pipeline L2 may be inserted.

In the present way, in the exemplary embodiment of the present disclosure, when the connector 1 and the second pipeline L2 are not connected to each other, the opening of the second body portion 14 may be closed by the opening/closing body 20 and the elastic body 30, and thus, the cooling fluid accommodated in the first pipeline L1 and the connector body 10 may be prevented from being leaked to the outside thereof.

Referring to FIG. 3, FIG. 4, and FIG. 5, the portion L2a of the second pipeline L2 may be inserted into the opening provided in the second body portion 14 of the main connector 1. As the portion L2a of the second pipeline L2 enters an inside of the second body portion 14, the opening/closing surface 22a of the opening/closing body 20 may be pressed by the second pipeline L2.

Accordingly, when a force, by which the second pipeline L2 presses the opening/closing surface 22a, becomes higher than the elastic support force of the elastic body 30, the opening/closing portion 22 may deviate from the closing position. As the portion L2a of the second pipeline L2 further enters the inside of the second body portion 14, the opening/closing portion 22 may enter the accommodation space while being rotated about the rotation shaft 24. That is, the opening/closing body 20 may be moved to the opening position.

Accordingly, the connection passage L_10 of the connector body 10 and the second pipeline L2 may communicate with each other, and the first pipeline L1 and the second pipeline L2 may be connected to each other. Accordingly, when the opening/closing body 20 opens the connection passage L_10, the portion L2a of the second pipeline L2 is sufficiently inserted into the opening of the second body portion 14, and thus, the cooling fluid may not be leaked through the opening of the second body portion 14 even when the opening/closing body 20 opens the connection passage L_10.

Through the above-described process, the connector 1 according to the exemplary embodiment of the present disclosure may prevent the cooling fluid from being leaked to the outside during a process of connecting the first pipeline L1 and the second pipeline L2.

Hereinafter, it will be described that the leakage of the cooling fluid is prevented in a process of disconnecting the first pipeline and the second pipeline by the connector according to the various exemplary embodiments of the present disclosure.

As illustrated in FIG. 3, when the portion L2a of the second pipeline L2 is inserted into the inside of the second body portion 14, the opening/closing body 20 may be located in the opening position, and the first pipeline L1 and the second pipeline L2 may communicate with each other through a connection passage L_10.

Referring to FIG. 4 and FIG. 5, as illustrated in FIG. 4, when the portion L2a of the second pipeline L2 is extracted from the second body portion 14, the opening/closing portion 22 of the opening/closing body 20 may return to the closing position due to the elastic support force of the elastic body 30.

In the present way, in the connector 1 according to the exemplary embodiment of the present disclosure, the opening/closing body 20 may immediately block and close the connection passage L_10 when the connection between the second pipeline L2 and the connector body 10 is released, and thus the cooling fluid may be prevented from being leaked to the outside thereof.

Hereinafter, a connector according to another exemplary embodiment of the present disclosure will be described in different drawings.

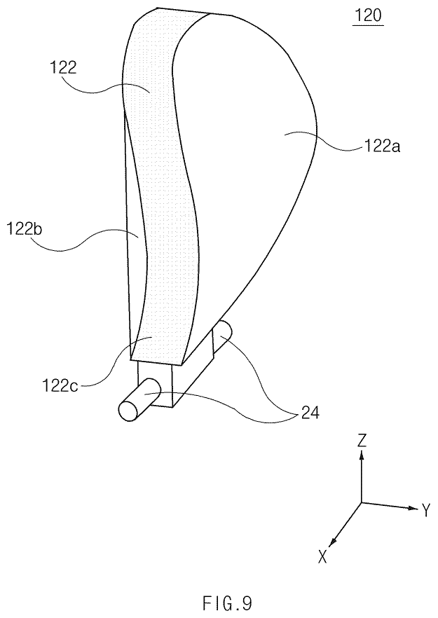

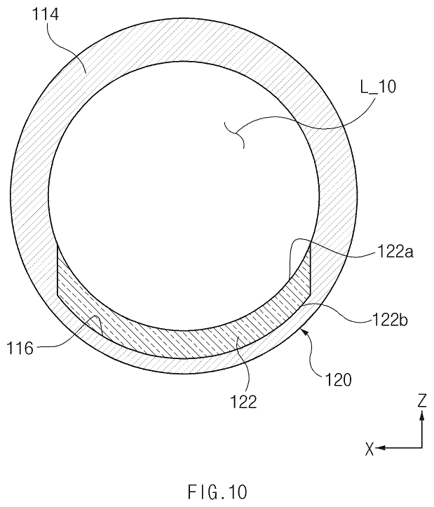

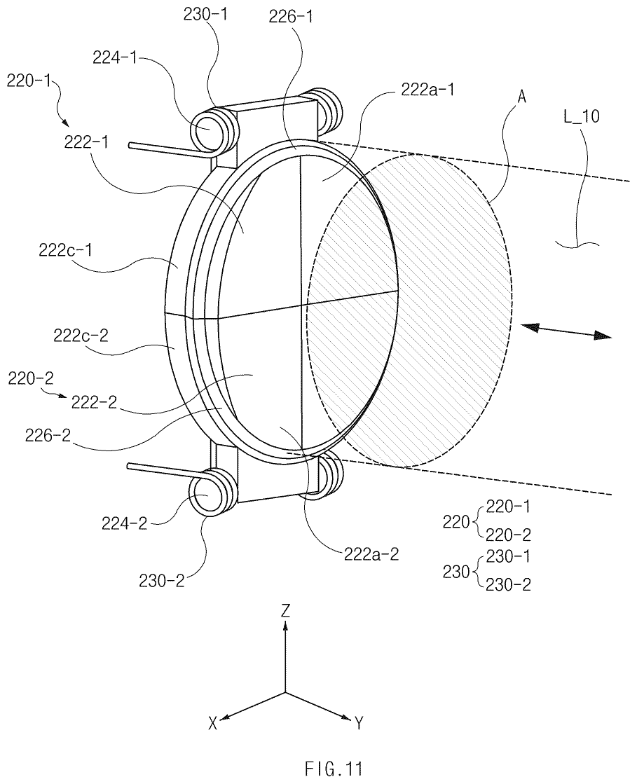

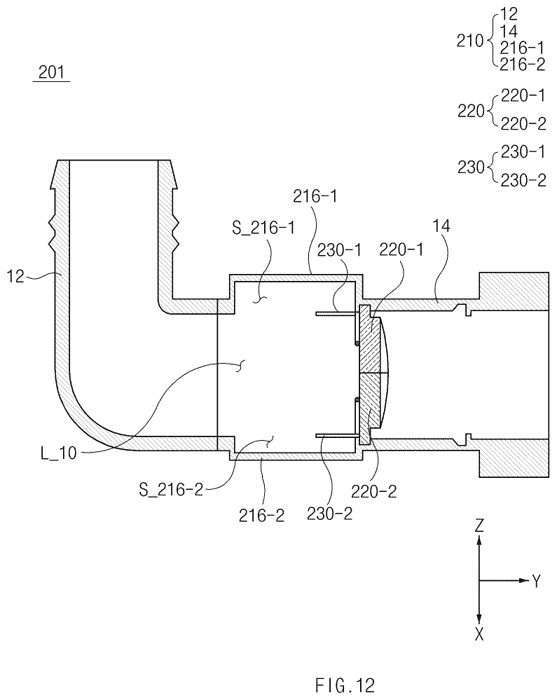

FIG. 9 is a perspective view of an opening/closing body of a connector according to various exemplary embodiments of the present disclosure, when viewed from a top. FIG. 10 is a cross-sectional view of a connector according to the various exemplary embodiments of the present disclosure, taken along a plane which is perpendicular to a forward/rearward direction thereof. FIG. 11 is a perspective view of an opening/closing body and an elastic body of a connector according to the various exemplary embodiments of the present disclosure, when viewed from a top. Accordingly, a connection passage is indicated by a dotted line, and a flow surface is indicated by a hatched surface. FIG. 12 is a longitudinal cross-sectional view of a connector according to various exemplary embodiments of the present disclosure.

FIG. 9 and FIG. 10 disclose a connector according to the various exemplary embodiments of the present disclosure. Referring to FIG. 10, in the exemplary embodiment of the present disclosure, an accommodation portion 116 may not protrude (or extend) from a second body portion 114 in an outward direction of the second body portion 114.

Instead, the accommodation portion 116 may be formed as the internal peripheral surface of the second body portion 114 is recessed in an outward direction of the second body portion. Accordingly, in the exemplary embodiment of the present disclosure, the connector body may be provided in a more compact and simple structure.

Referring to FIG. 9 and FIG. 10, the opening/closing body 20 of the connector according to the various exemplary embodiments of the present disclosure may include an opening/closing portion 122 including an opening/closing surface 122a. When the opening/closing portion 122 is located in the opening position inserted into the accommodation portion 116, the opening/closing surface 122a may be formed as a concave curved surface to be connected to the internal peripheral surface of the second body portion 114.

Accordingly, a curvature of the opening/closing surface 122a may be the same as a curvature of the internal peripheral surface of the second body portion 114. Accordingly, when the opening/closing body 120 is located in the opening position, the cooling fluid may flow more smoothly on the opening/closing surface 122a.

FIG. 11 and FIG. 12 disclose a connector according to the various exemplary embodiments of the present disclosure. Referring to FIG. 12, the second body portion 14 of a connector 201 according to the various exemplary embodiments of the present disclosure may include a plurality of accommodation portions 216-1 and 216-2. As illustrated, the plurality of accommodation portions 216-1 and 216-2 include a first accommodation portion 216-1 which is formed at an upper portion of the second body portion 14 and a second accommodation portion 216-2 which is formed at a lower portion thereof.

Accordingly, the first accommodation portion 216-1 may include a first accommodation space S_216-1. The first accommodation space S_216-1 may be connected to the connection passage L_10 and may be formed to be recessed from the second body portion 14 toward an upper side of the second body portion 14. The first accommodation space S_216-1 may be a space, which a first opening/closing body 220-1, which will be described later, enters to be located in the opening position.

Furthermore, the second accommodation portion 216-2 may include a second accommodation space S_216-2. The second accommodation space S_216-2 may be connected to the connection passage L_10, and may be concavely recessed from the second body portion 14 toward a lower side of the second body portion 14. The second accommodation space S_216-2 may be a space, which a second opening/closing body 220-2, which will be described later, enters to be located in the opening position.

The number of such accommodation portions 216 may correspond to the number of opening/closing bodies 230 that will be described later. Of course, when one accommodation portion 216 is configured to accommodate a plurality of opening/closing bodies 230, the number of accommodation portions 216 may be smaller than the number of opening/closing bodies 230.

Referring to FIG. 11 and FIG. 12, a plurality of opening/closing bodies 220 may be provided in the connector 201 according to the various exemplary embodiments of the present disclosure, and may each open or close a portion of the connection passage L_10. As illustrated, the opening/closing body 220 may include a first opening/closing body 220-1 for opening and closing an upper side of the connection passage L_10 and a second opening/closing body 220-2 for opening and closing a lower side thereof.

Accordingly, the opening/closing portion 222-1 of the first opening/closing body 220-1 and the opening/closing portion 222-2 of the second opening/closing body 220-1 includes a shape, in which the opening/closing portion 22 (illustrated in FIG. 5 and FIG. 6) according to the various exemplary embodiments are cut in the leftward/rightward right direction (the X-axis direction).

In more detail, the opening/closing portion 222-1 of the first opening/closing body 220-1 may be provided in the same manner as an upper side of the opening/closing portion 22 (illustrated in FIG. 5 and FIG. 6) according to the various exemplary embodiments of the present disclosure, and the opening/closing portion 222-2 of the second opening/closing body 220-2 may be provided in the same manner as a lower side of the opening/closing portion 22 (illustrated in FIG. 5 and FIG. 6) according to the various exemplary embodiments of the present disclosure. Accordingly, the opening/closing portion 222-1 of the first opening/closing body 220-1 and the opening/closing portion 222-2 of the second opening/closing body 220-2 may open or close an upper side and a lower side of a flow surface “A”, respectively.

In the exemplary embodiment of the present disclosure, the opening/closing portion 222-1 may include an opening/closing surface 222a-1, a facing surface, and an external circumferential surface 222c-1.

In the exemplary embodiment of the present disclosure, a sealing portion 226-1 may be provided in the external circumferential surface 222c-1.

In the exemplary embodiment of the present disclosure, the opening/closing portion 222-2 may include an opening/closing surface 222a-2, a facing surface, and an external circumferential surface 222c-2.

In the exemplary embodiment of the present disclosure, a sealing portion 226-2 may be provided in the external circumferential surface 222c-2.

In the exemplary embodiment of the present disclosure, a rotation shaft 224-1 of the first opening/closing body 220-1 may be connected to an upper side of the opening/closing portion 222-1. Furthermore, the rotation shaft 224-1 may be coupled to an upper side of the second body portion 14 to be rotatable.

In the exemplary embodiment of the present disclosure, a rotation shaft 224-2 of the second opening/closing body 220-2 may be connected to a lower side of the opening/closing portion 222-2. Furthermore, the rotation shaft 224-2 may be coupled to a lower side of the second body portion 14 to be rotatable.

Referring back to FIGS. 11 to 12, the connector 1 according to the various exemplary embodiments of the present disclosure may include an elastic body 230. Accordingly, a plurality of elastic bodies 230 may be provided to elastically support the plurality of opening/closing bodies 220, respectively. As illustrated, the elastic body 230 may include a first elastic body 230-1 that elastically supports the first opening/closing body 220-1 and a second elastic body 230-2 that elastically supports the second opening/closing body 220-2. Accordingly, each elastic body 230 may be configured identically to the elastic body 30 (illustrated in FIG. 5 and FIG. 6) of the connector according to the various exemplary embodiments of the present disclosure.

Meanwhile, in the connector 201 according to the various exemplary embodiments of the present disclosure, two opening/closing bodies 220 are provided to open or close an upper side and a lower side of the flow surface “A”, respectively, but the number of the opening/closing bodies 220 may be appropriately adjusted when necessary.

For example, four opening/closing bodies may be provided to open, and the four opening/closing bodies may close a left upper side, a left lower side, a right upper side, and a right lower side of the flow surface, respectively. In the instant case, the opening/closing portion of each opening/closing body 220 may be a portion which is formed by cutting the opening/closing portion 22 (illustrated in FIG. 5 and FIG. 6) according to the various exemplary embodiments in the leftward/rightward direction (the X-axis direction) and the upward/downward direction (the Z-axis direction).

Meanwhile, the connector according to the exemplary embodiment of the present disclosure described above has been described, assuming that the pipeline of the circulation system provided in the movable object is connected to the pipeline of the circulation system provided in the cargo loading structure. However, the pipelines which may be connected by the connector according to the exemplary embodiment of the present disclosure are not limited to those described above, and the connector according to the exemplary embodiment of the present disclosure may be used to connect various types of pipelines.

According to one aspect of the present disclosure, the opening/closing body closes the connection passage provided in the connector body based on the elastic support force of the elastic body, but opens the connection passage when another pipeline enters it while overcoming the elastic support force, and thus, leakage of fluid may be prevented during the process of connecting or disconnecting the pipelines.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A connector for connecting a first pipeline and a second pipeline, the connector comprising:
a connector body including a connection passage configured to connect the first pipeline and the second pipeline;
an opening/closing body movably coupled to the connector body to be movable between an opening position, in which the connection passage is opened, and a closing position, in which the connection passage is closed; and
an elastic body coupled to the connector body and configured to elastically support the opening/closing body toward the closing position.

2. The connector of claim 1,
wherein the connector body includes a hollow body portion including an opening on one side of the connector body, and
wherein the opening/closing body is located on an inside of the body portion.

3. The connector of claim 2, wherein the connector body further includes:
a movement restricting portion configured to restrict the opening/closing body from being moved from the closing position toward the opening of the body portion.

4. The connector of claim 3, wherein the movement restricting portion protrudes from an internal peripheral surface of the body portion so that the opening/closing body is stopped by the movement restricting portion.

5. The connector of claim 2, wherein the opening/closing body includes:
a rotation shaft coupled to the body portion to be rotatable; and
an opening/closing portion connected to the rotation shaft to be rotatable about the rotation shaft, and configured to block an interior of the body portion in the closing position.

6. The connector of claim 5, wherein the opening/closing portion is formed in a plate shape.

7. The connector of claim 6,
wherein a cross-section of the body portion, which is perpendicular to a flow direction of a fluid in the body portion, is circular or elliptical, and
wherein the opening/closing portion is formed of a circular or elliptical plate.

8. The connector of claim 7, wherein the opening/closing body further includes:
a sealing portion provided on a peripheral side of the opening/closing portion.

9. The connector of claim 8, wherein the sealing portion is provided in an external circumferential surface facing an internal peripheral surface of the body portion in the closing position.

10. The connector of claim 9, wherein the sealing portion includes an O-ring surrounding the opening/closing portion.

11. The connector of claim 5, wherein the connector body further includes:
an accommodation portion formed at a side portion of the body portion, and including an accommodation space connected to an interior of the body portion, and
wherein at least a part of the opening/closing portion is disposed in the accommodation space in the opening position.

12. The connector of claim 11, wherein the accommodation portion includes a recess recessed in an outward direction of the body portion on an internal wall of the body portion.

13. The connector of claim 11,
wherein the opening/closing portion includes an opening/closing surface disposed to face the opening of the body portion in the closing position, and configured to block an interior of the body portion, and
wherein the opening/closing surface includes a concave shape recessed in an outward direction of the body portion in the opening position.

14. The connector of claim 5, wherein the elastic body is a torsion spring coupled to the rotation shaft.

15. The connector of claim 14, wherein the elastic body includes:
a pair of spring portions coupled to opposite end portions of the rotation shaft, respectively;
a pair of fixed portions extending from the pair of spring portions, respectively, and fixed to the body portion; and
an elastic support portion provided between the pair of spring portions so that the opening/closing portion is supported toward the closing position by use of elasticity of the spring portion.

16. The connector of claim 1,
wherein the opening/closing body is in plural, and
wherein the plurality of opening/closing bodies are provided to open or close a portion of the connection passage.

17. The connector of claim 16, wherein a plurality of elastic bodies are provided to correspond to a number of the plurality of opening/closing bodies to elastically support the plurality of opening/closing bodies, respectively.

18. The connector of claim 16, wherein when a cross-section of the connection passage, which is perpendicular to a flow direction of a fluid, is defined as a flow surface,
the opening/closing bodies are configured to open or close different portions of the flow surface, respectively so that the plurality of opening/closing bodies open or close the flow surface.

19. A movable object comprising:
a vehicle body including a wheel for traveling;
a first circulation system supported by the vehicle body;
a structure coupled to the vehicle body;
a second circulation system supported by the structure; and
a connector detachably connecting a first pipeline of the first circulation system and a second pipeline of the second circulation system,
wherein the connector includes:
a connector body including a connection passage configured to connect the first pipeline and the second pipeline;
an opening/closing body coupled to be movable from an opening position, in which the connection passage is opened, to a closing position, in which the connection passage is closed, in the connector body; and
an elastic body coupled to the connector body and configured to elastically support the opening/closing body toward the closing position.

20. The movable object of claim 19,
wherein the structure is coupled to be attached to or detached from the vehicle body, and
wherein the opening/closing body is configured to open the connection passage in response that the structure is coupled to the vehicle body, and close the connection passage in response that the structure is decoupled from the vehicle body.
